(19) United States
(12) Patent Application Publication
(10) Pub. No.: US 2014/0111450 A1
(43) Pub. Date: Apr. 24, 2014

(54) TOUCH PANEL DEVICE WITH RECONFIGURABLE SENSING POINTS AND ITS SENSING METHOD

(71) Applicant: SUPERC-TOUCH CORPORATION, NEW TAIPEI CITY (TW)

(72) Inventor: Hsiang-Yu LEE, New Taipei City (TW)

(73) Assignee: SUPERC-TOUCH CORPORATION, NEW TAIPEI CITY (TW)

(21) Appl. No.: 14/053,996

(22) Filed: Oct. 15, 2013

(30) Foreign Application Priority Data
Oct. 22, 2012 (TW) 101138865

(51) Int. Cl. G06F 3/041

(52) U.S. Cl. CPC G06F 3/041
USPC 345/173

(57) ABSTRACT

A touch panel device with reconfigurable sensing points includes a panel, a plurality of sensing points, a plurality of selectors, and a controller. The sensing points, are arranged on the panel for sensing a touch generated from an external object and generating a corresponding signal. Each selector has a first terminal connected to a corresponding sensing point, a second terminal connected to a common output terminal, and a control terminal. The controller is connected to the control terminal of each selector for controlling the plurality of selectors to be electrically connected to the common output terminal or not. The controller configures the control terminals of the plurality of selectors to allow some of the sensing points to be electrically connected to the common output terminal, so as to proceed with a hierarchical block touch sensing.

### FIELD OF THE INVENTION

The present invention relates to the technical field of touch panels and, more particularly, to a touch panel device with reconfigurable sensing points and its sensing method.

### DESCRIPTION OF RELATED ART

The principle of touch panels is based on different sensing manners to detect a voltage, current, acoustic wave, or infrared to thereby detect the coordinates of touch points on a screen where a finger or other medium touches. For example, a resistive touch panel uses a potential difference between the upper and lower electrodes to compute the position of a pressed point for detecting the location of the touch point, and a capacitive touch panel uses a capacitance change generated in an electrostatic combination of the arranged transparent electrodes with a human body to generate a current or voltage for detecting touching coordinates.

Upon the capacitive touch principle, the capacitive touch technologies can be divided into a surface capacitive touch sensing and a projected capacitive touch sensing. Further, the projected capacitive touch sensing can be divided into a self capacitance and a mutual capacitance sensing.

FIG. 1 is a schematic view of a well-known self capacitance sensing. As shown in FIG. I, there are m columns of electrode points arranged in an X direction and n rows of electrode points arranged in a Y direction on a touch panel. Each electrode point 110 is electrically connected to a multiplexer 120 and further connected to a driving and sensing unit (not shown). The multiplexer 120 is an m×n-to-one multiplexer such that the m×n electrode points 110 can be connected to the driving and sensing unit. When a self capacitance sensing is performed, the driving and sensing unit sequentially drives one of the electrode points 110 to sense the voltage.

Thus, sensing a touch plane is complete with m×n times of driving and sensing operations.

FIG. 2 is a schematic view of another well-known self capacitance sensing. As shown in FIG. 2, at the first time period, the driving and sensing units 210 in a first direction drive the conductor lines in the first direction in order to charge the self capacitance (Cs) of the conductor lines in the first direction. At the second period, the driving and sensing units 210 sense the voltages on the conductor lines in the first direction to thereby obtain n data. At the third period, the driving and sensing units 220 in a second direction drive the conductor lines in the second direction in order to charge the self capacitance of the conductor lines in the second direction. At the fourth period, the driving and sensing units 220 sense the voltages on the conductor lines in the second direction to thereby obtain in data. Therefore, there are m+n data obtained in total. In this case, sensing a touch plane is complete with m+n times of driving and sensing operations.

The well-known self capacitance sensing of FIG. 2 connects both a driving circuit and a sensing circuit on the same conductor line in order to drive the conductor line and sense a signal change on the same conductor line to thereby decide a magnitude of the self capacitance. In this case, the advantages include a reduced amount of data since the well-known touch panel has m+n data in a single image only, so as to save the hardware cost. Due to the reduced amount of data to be processed, lower power consumption and higher point report rate are obtained.

FIG. 3 is a schematic diagram of a well-known mutual capacitance, therein by sensing a magnitude change of mutual capacitance Cm to thereby determine whether an object approaches the touch panel. Likewise, the mutual capacitance Cm is not a physical capacitor but a mutual capacitance between the conductor lines in the first direction and in the second direction.

As shown in FIG. 3, the drivers 310 are arranged on a first direction (Y direction), and the sensors 320 are arranged on a second direction (X direction). At the first half cycle of a first time periodT1, the drivers 310 drive the conductor lines 330 in the first direction and use the voltage Vy_1 to charge the mutual capacitance (Cm) 350. At the second half cycle of the first time period T1, all sensors 320 sense voltages (Vo_1, Vo_2, . . . , Vo_m) on the conductor lines 340 in the second direction to thereby obtain m data. Accordingly, the m×n data can be obtained after n driving periods. In this case, sensing a touch plane is complete with m×n times of driving and sensing operations. Such a mutual capacitance (Cm) sensing has the advantages of easily determining whether a touch is caused by a human body since the directions of signals induced from a floating conductor and from a grounded conductor are different. Also, since every touch point is indicated, by a real coordinate, the real position of each point can be found when multiple points are concurrently touched, such that the mutual capacitance (Cm) sensing can easily support the multi-touch applications.

However, no matter for the self capacitance sensing or the mutual capacitance sensing, there are at least m+n. times of driving and sensing operations required to complete a touch plane sensing. When the touch panel becomes larger or its resolution increases, the time of sensing a touch plane is relatively increased to thus limit the resolution and reduce the point report rate.

Therefore, it is desirable to provide an improved capacitive touch panel to mitigate and/or obviate the aforementioned problems.

### SUMMARY OF THE INVENTION

The object of the present invention is to provide a touch panel device with reconfigurable sensing points and its sensing method, which can effectively reduce a number of touch sensing and further the time required for sensing a touch, so as to increase the resolution and the point report rate.

According to a feature of the invention, there is provided a touch panel device with reconfigurable sensing points, which includes a panel, a plurality of sensing, points, a plurality of selectors, and a controller. The sensing points are arranged on the panel for sensing a touch generated from an external object and generating a corresponding signal. Each selector has a first terminal connected to a corresponding sensing point, and a second terminal connected to a common output terminal. The controller is connected to a control terminal of each selector for controlling the plurality of selectors to be electrically connected to the common output terminal or not. The controller configures the control terminals of the plurality of selectors to allow a portion of the plural sensing points to be electrically connected to the common output terminal, so as to proceed with a hierarchical block touch sensing.

According to another feature of the present invention, there is provided a sensing method implemented in a touch panel device with reconfigurable sensing points. The touch panel device includes a plurality of sensing points arranged on a panel, and a controller. The sensing points sense a touch caused by an external object. The controller groups the plurality of sensing points into a plurality of blocks, and treats each block as a sensing unit, to thereby proceed with a hierarchical block touch sensing. The method comprises: using the controller to group the plurality of sensing points into N1 first sensing blocks, so as to perform N1 times of touch sensing, respectively, where N1 is an integer greater than one; and using the controller to select one of the N1 first sensing blocks based on a result of performing the N1 times of touch sensing and to group the sensing points of the selected first sensing block into N2 second sensing blocks, so as to perform N2 times of touch sensing, respectively, where N2 is an integer greater than one.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a well-known self capacitance sensing;

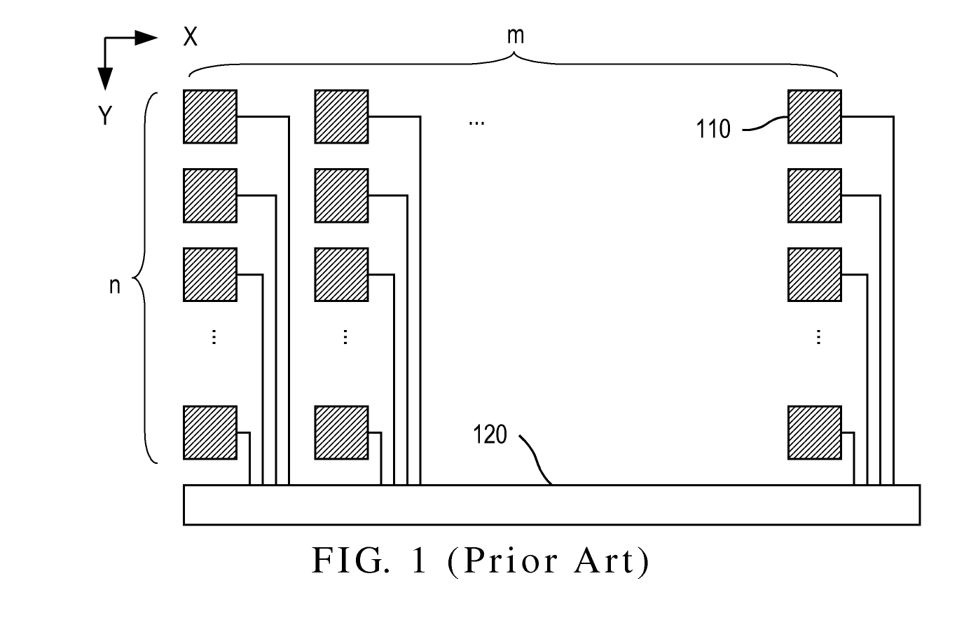

FIG. 2 is a schematic view of another well-known self capacitance sensing;

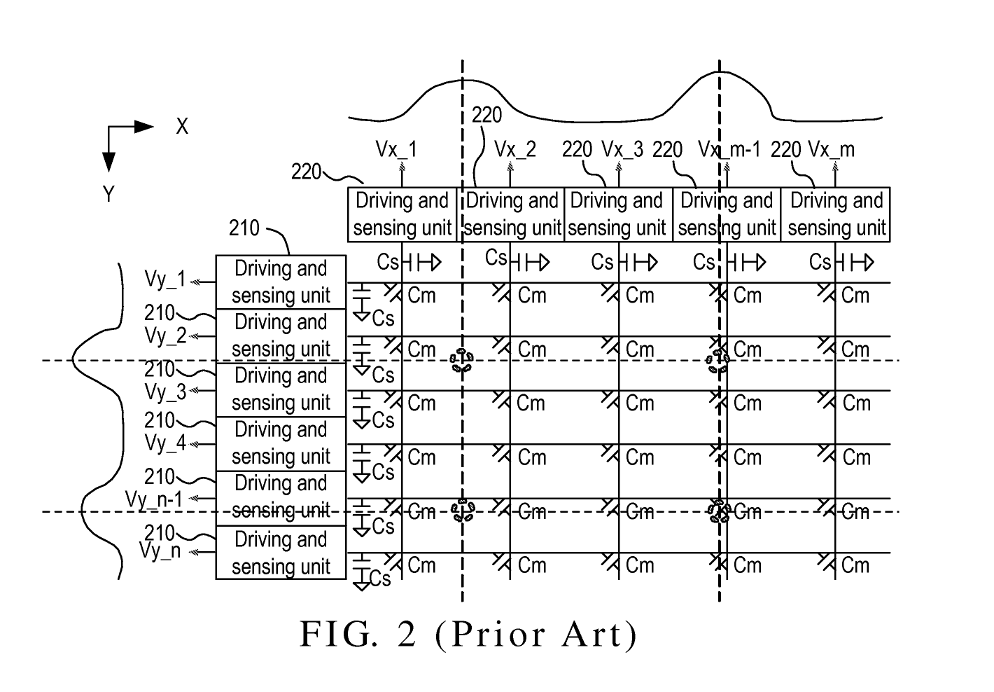

FIG. 3 is a schematic view of a well-known mutual capacitance sensing;

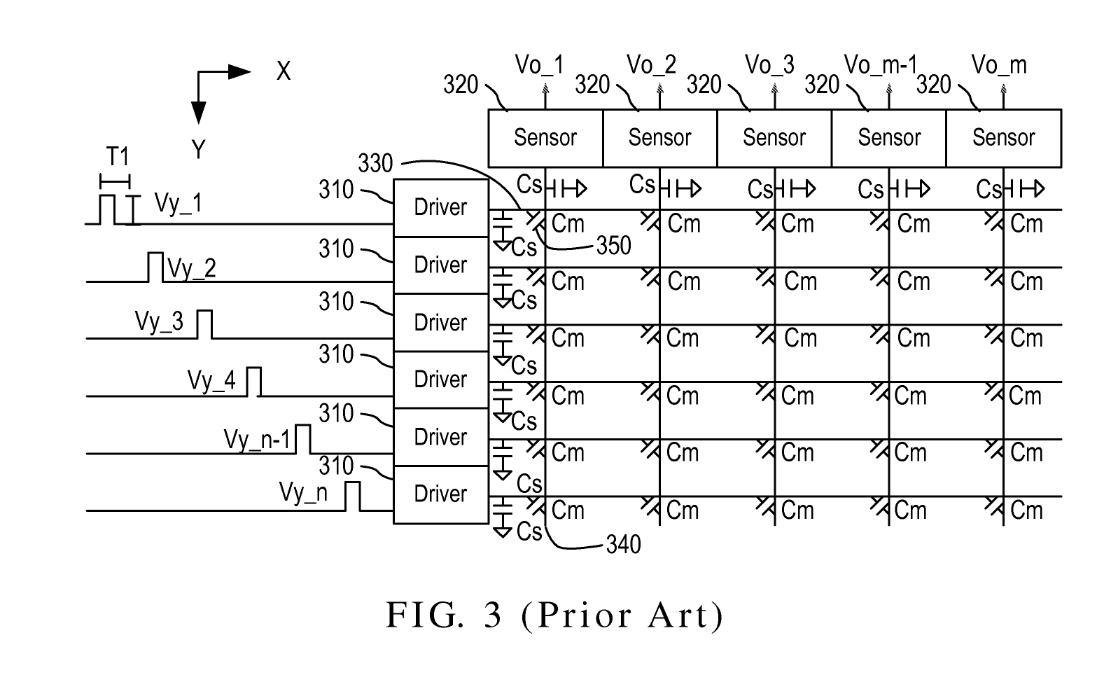

FIG. 4 is a block diagram of a touch panel device with reconfigurable sensing points according to the invention;

FIG. 5 is a circuit diagram of a selector according to the invention;

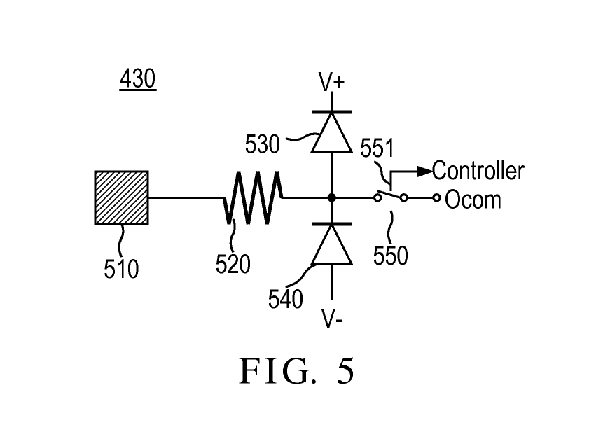

FIG. 6 is a schematic diagram of a hierarchical block touch sensing according to the invention;

FIG. 7 is a schematic diagram of another hierarchical block touch sensing according to the invention;

FIG. 8 is a schematic diagram of a further hierarchical block touch sensing according to the invention;

FIG. 9 is a schematic diagram of an application of a hierarchical block touch sensing according to the invention;

FIG. 10 is a circuit diagram of a well-known selector; and

FIG. 11 is a flowchart of a touch sensing method according to the invention.

### DETAILED DESCRIPTION OF THE PREFERRED EMBODIMENT

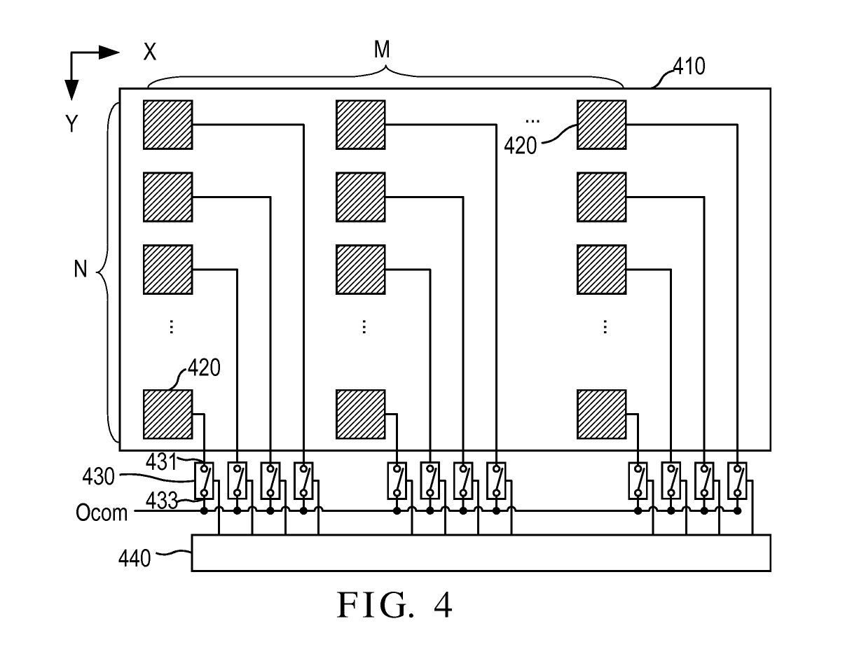

FIG. 4 is a block diagram of a touch panel device 400 with reconfigurable sensing points according to the invention. The touch panel device 400 includes a panel 410, a plurality of sensing points 420, a plurality of selectors 430, and a controller 440.

The sensing points 420 are arranged on the panel 410 for sensing a touch generated from an external object (not shown) and generating a corresponding signal. There are a total amount of M×N sensing points 420 arranged on the panel 410 in a matrix form, including M sensing points in a first direction (X direction) and N sensing points in a second direction (Y direction), where M, N are each an integer greater than one, and the first direction is substantially vertical to the second direction. Each of the selectors 430 has a first terminal 431 connected to a corresponding sensing point 420, and a second terminal 433 connected to a common output terminal Ocom.

FIGS is a circuit diagram of the selector according to the invention. The selector 430 includes a lead 510, a resistor 520, a first diode 530, a second diode 540, and a switch 550.

The lead 540 is connected to the corresponding sensing point 420 through the first terminal 431 of the selector 430. The resistor 520 has one end connected to the lead 510. The first diode 530 has an anode connected to the other end of the resistor 520, and a cathode connected to a high voltage (V+). The second diode 540 has a cathode connected to the other end of the resistor 520, and an anode connected to a low voltage (V−). The switch 550 has one end connected to the other end of the resistor 520, another end connected to the common output terminal Ocom, and a control terminal 551 connected to the controller 440.

The controller 440 is connected to the control terminal 551 of each selector 430 for controlling the plurality of selectors 430 to be electrically connected to the common output terminal Ocom or not.

The controller 440 configures the control terminals 551 of the plurality of selectors 430 to allow a portion of the plural sensing points 420 to be electrically connected to the common output terminal, so as to proceed with a hierarchical block touch sensing. Namely, the controller 440 configures the control terminals 551 of the selectors 430 for grouping the sensing points 420 into a plurality of blocks, and treats each block as a sensing unit, so as to proceed with a hierarchical block touch sensing.

The controller 440 groups the M×N sensing points 420 into N1 first sensing blocks to thereby perform N1 times of touch sensing, respectively, where N1 is an integer greater than one. The controller 440 is based on a result of performing the N1 times of touch sensing to select one of the N1 first sensing blocks, and groups the e sensing points of the selected first sensing block into N2 second sensing blocks to thereby perform N2 times of touch sensing, respectively, where N2 is an integer greater than one.

The controller 440 is based on a result of performing the N2 times of touch sensing to select one of the N2 second sensing blocks, and groups the sensing points of the selected second sensing block into N3 third sensing blocks to thereby perform N3 times of touch sensing, where N3 is an integer greater than one. The three-hierarchical block touch sensing is described above for the M×N sensing points 420, but upon the invention a higher hierarchical block touch sensing can be performed by those skilled in the art, and thus a detailed description is deemed unnecessary.

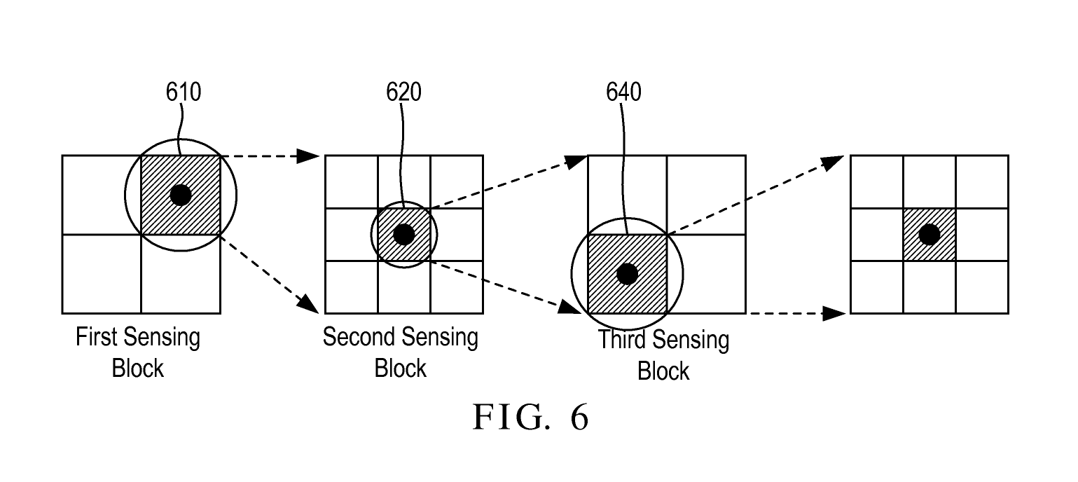

FIG. 6 is a schematic diagram of a hierarchical block touch sensing according to the invention. The controller 440 groups the M×N sensing points into four (N1=4) first sensing blocks to thereby perform four times of touch sensing, respectively.

When the controller 440 determines a touch position located in a first sensing block 610, it is based on the result to select the first sensing block 610 among the four first sensing blocks, and groups the sensing points of the selected first sensing block 610 into nine (N2=9) second sensing blocks to thereby perform nine times of touch sensing, respectively.

When the controller 440 determines a touch position located in a second sensing block 620, it is based on the result to select the second sensing block 620 among the nine second sensing blocks, and groups the sensing points of the selected second sensing block 620 into four (N3=4) third sensing blocks to thereby perform four times of touch sensing, respectively.

When the controller 440 determines a touch position located in a third sensing block 640, it is based on the result to select the third sensing block 640 among the four third sensing blocks, and groups the sensing points of the selected third sensing block 640 into nine (N4=9) fourth sensing blocks to thereby perform nine times of touch sensing, respectively.

From aforementioned description, it is known that the invention requires only 26(=4+9+4+9) sense operations of a hierarchical block touch sensing, however can implement a touch resolution of 1296(4×9×4×9).

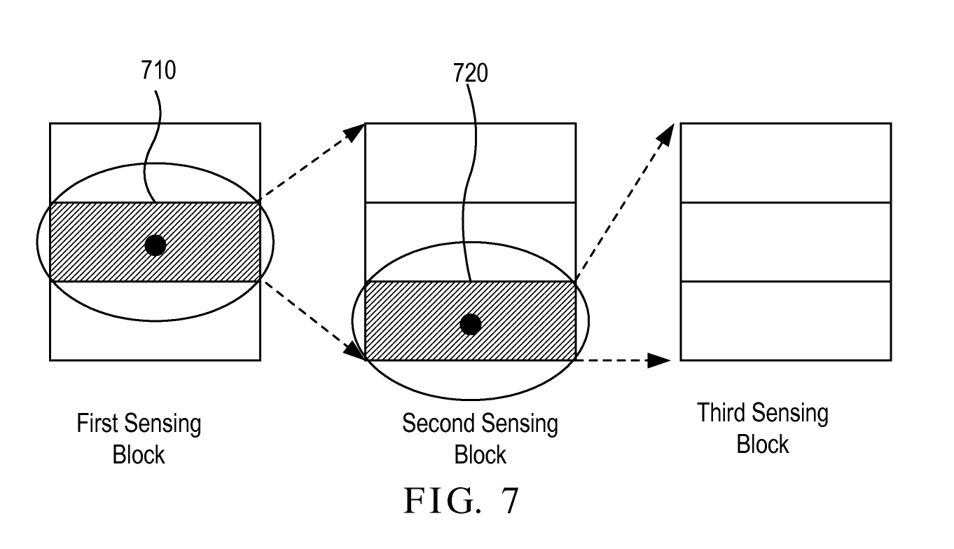

FIG. 7 is , a schematic diagram of another hierarchical block touch sensing according to the invention, which performs a hierarchical block touch sensing in the row direction. The controller 440 is based on the row direction to group the M×N sensing points 420 into three (N1=3) first sensing blocks to thereby perform three times of touch sensing.

When the controller 440 determines a touch position located in a first sensing block 710, it is based on the result to select the first sensing block 710 among the three first sensing blocks, and groups the sensing points of the selected first sensing block 710 into three (N2=3) second sensing blocks to thereby perform three times of touch sensing.

When the controller 440 determines a touch position located in a second sensing block 720, it is based on the result to select the second sensing block 720 among the three second sensing blocks, and groups the sensing points of the selected second sensing block 720 into three (N3=3) third sensing blocks to thereby perform three times of touch sensing.

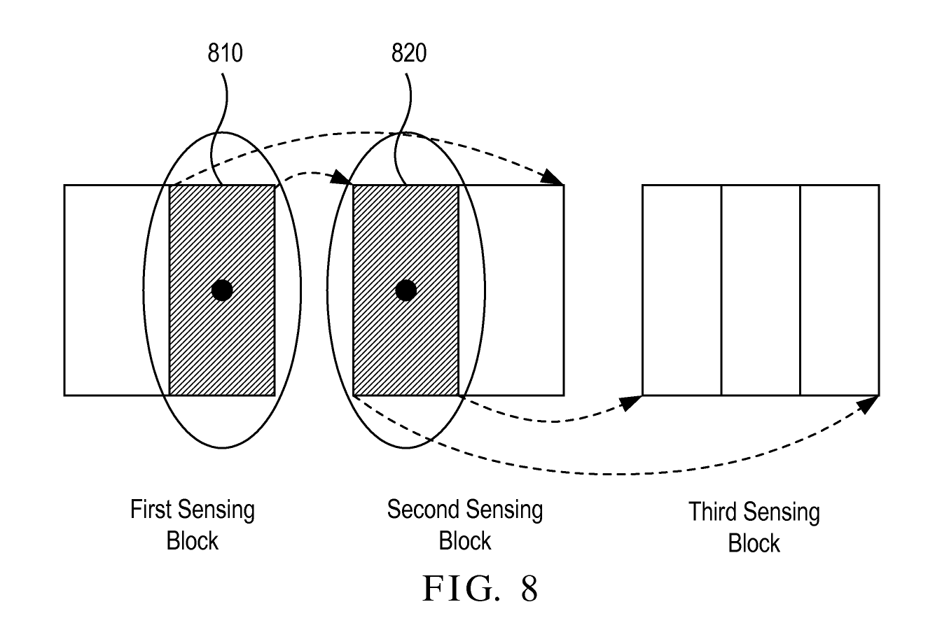

FIG. 8 is a schematic diagram of a further hierarchical block touch sensing according to the invention, which performs a hierarchical block touch sensing in the column direction. The controller 440 is based on the column direction to group the M×N sensing points 420 into two (N1=2) first sensing blocks to thereby perform two times of touch sensing.

When the controller 440 determines a touch position located in a first sensing block 810, it is based on the result to select the first sensing block 810 among the two first sensing blocks, and groups the sensing points of the selected first sensing block 810 into two (N2=2) second sensing blocks to thereby perform two times of touch sensing.

When the controller 440 determines a touch position located in a second sensing block 820, it is based on the result to select the second sensing block 820 among the two second sensing blocks, and groups the sensing points of the selected second sensing block 820 into three (N3=3) third sensing blocks to thereby perform three times of touch sensing.

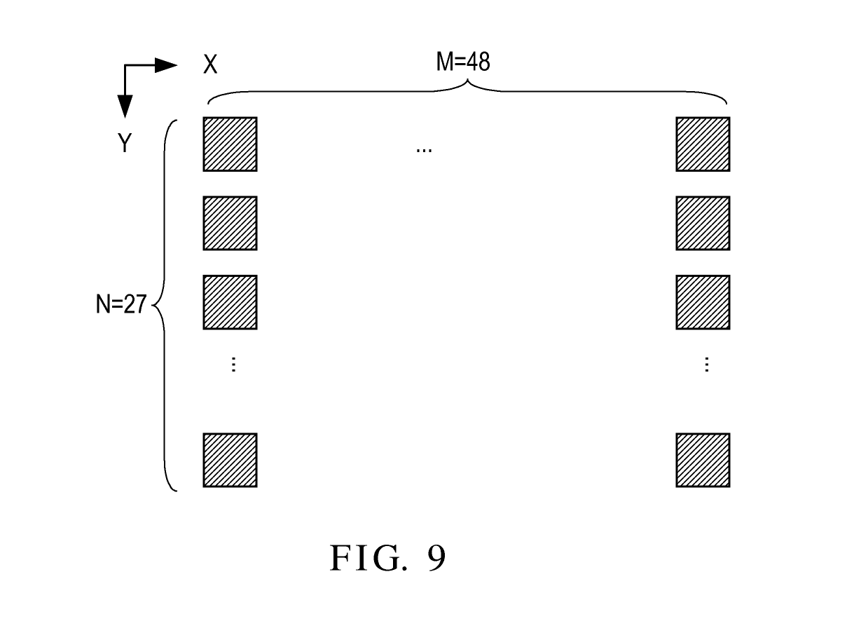

FIG. 9 is a schematic diagram of an application of a hierarchical block touch sensing according to the invention. In FIG, 9, we have M=48, N=27, and there are 48×27 sensing points. Based on the aforementioned description, it is known that the 27 rows are sequentially grouped, in hierarchy, into three, three, and three sensing blocks for performing a three-hierarchical block touch sensing in row direction, so that only 9(=3+3+3) times of touch sensing are performed to thereby decide which row of the sensing points the touch point locates. Similarly, the 48 columns are sequentially grouped, in hierarchy, into two, two, two, two, and three sensing blocks for performing a five-hierarchical block touch sensing in column direction, so that only 11 (=2+2+2+2+3) times of touch sensing are performed to thereby decide which column of the sensing points the touch point locates. Therefore, a total of 20 (=9+11) times of touch sensing are performed to thus obtain the position of the touch point on the panel 410.

However, for locating the touch position in the prior art, the self capacitance touch sensing needs 75 (=48+27) times of touch sensing, and the mutual capacitance touch sensing needs 1296 (=48×27) times of touch sensing. Thus, the touch panel device 400 of the present invention can effectively decrease the required number of touch sensing and further reduce the required time for touch sensing, so as to increase the touch sensing resolution. Therefore, the present invention is suitable for a high-resolution touch panel device.

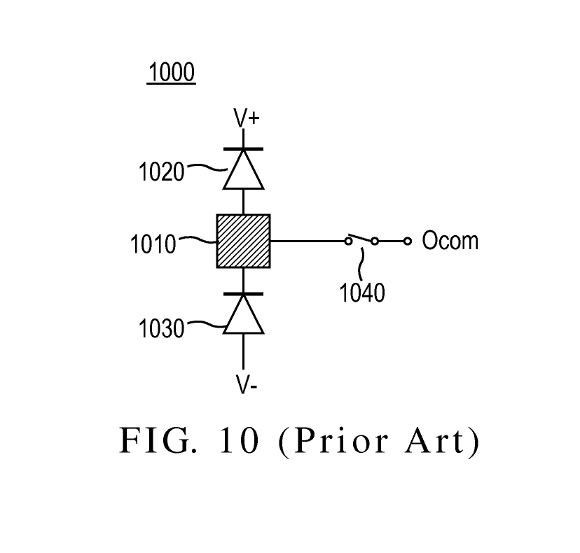

FIG. 10 schematically illustrates a circuit diagram of a well-known selector. In FIG. 10, the selector 1000 includes a lead 1010, two diodes 1020, 1030, and a switch 1040.

As shown in FIG. 10, due to the electrostatic discharge (ESD) protection, the size of the diode 1020 or 1030 is large for allowing an electrostatic current to pass therethrough and thus preventing the electrostatic current from entering the integrated circuit. Since the size of the diode 1020 or 1030 is large, the capacitance thereof is also high.

Therefore, if as shown in FIG. 4, a second terminal 433 of each of the selectors 430 is connected to a common output terminal Ocom, a relatively high capacitance effect will be formed on the common output terminal. Ocom. However, with the circuit of the selector in accordance with the present invention, each of the selectors has a resistor 520 to limit a magnitude of the electrostatic current, so that the sizes of the first diode 530 and second diode 540 can be reduced, and thus the capacitance thereof can also be reduced. Accordingly, when a second terminal 433 of each of the selectors 430 is connected to a common output terminal Ocom, the relatively high capacitance effect on the common output terminal Ocom does not occur.

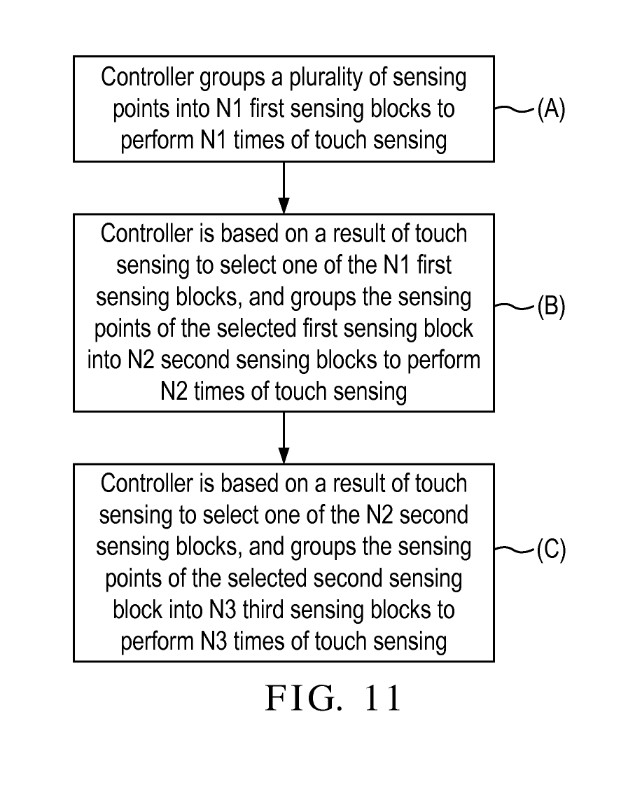

FIG. 11 is a flowchart of a touch sensing method according to the present invention. The touch sensing method is used in the touch panel device 400 with reconfigurable sensing points shown in FIG. 4. The touch panel device 400 includes a plurality of sensing points 420 arranged on a panel 410, and a controller 440. The sensing points 420 sense a touch generated from an external object. The controller 440 groups the plurality of sensing points 420 into a plurality of blocks, and treats each block as a sensing unit, to thereby proceed with a hierarchical block touch sensing.

The sensing points have a total amount of M×N arranged in a matrix form, including M sensing points in a first direction and N. sensing points in a second direction, where M, N are each an integer greater than one, and the first direction is substantially vertical to the second direction.

In step (A), the controller 440 groups the plurality of sensing points into N1 first sensing blocks to thereby perform N1 times of touch sensing, respectively, where N1 is an integer greater than one.

In step (B), the controller is based on a result of performing the N1 times of touch sensing to select one of the N1 first sensing blocks, and groups the sensing points of the selected first sensing block into N2 second sensing blocks to thereby perform N2 times of touch sensing, respectively, where N2 is an integer greater than one.

In step (C), the controller is based on a result of performing the N2 times of touch sensing to select one of the N2 second sensing blocks, and groups the sensing points of the selected second sensing block into N3 third sensing blocks to thereby perform N3 times of touch sensing, respectively, where N3 is an integer greater than one. Thus, the resolution of the touch sensing is N1×N2×N3 after the touch panel device 400 performs N1+N2+N3 times of touch sensing. In addition, based on the skill of the present invention, those skilled in the art can perform a hierarchical block touch sensing on the selected third sensing block, and such a hierarchical process can be repeated until a required touch sensing resolution is obtained.

As cited, the present invention uses the selectors 430 in the touch. sensing and groups the sensing points 420 into a plurality of blocks, and treats each block as a sensing unit, to thereby proceed with a hierarchical block touch sensing. Thus, the required number of touch sensing is decreased and the required time for touch sensing is further reduced, so as to increase the touch sensing resolution. When the touch sensing resolution of the touch panel device is increased, the number of the self or mutual capacitance sensing in the prior art is also increased, which is not suitable for high-resolution touch devices. However, in the present invention, with the increase of the touch sensing resolution, the number of the touch sensing will not be linearly increased. Accordingly, the present invention is particularly suitable for the high-resolution touch devices.

Although the present invention has been explained in relation to its preferred embodiment, it is to be understood that many other possible modifications and variations can be made without departing from the spirit and scope of the invention as hereinafter claimed.

What is claimed is:

1. A touch panel device with reconfigurable sensing points, comprising:
a panel;
a plurality of sensing points arranged on the panel for sensing a touch generated from an external object and generating a corresponding signal;
a plurality of selectors, each having a first terminal connected to a corresponding sensing point and a second terminal connected to a common output terminal; and
a controller connected to a control terminal of each of the selectors for controlling the selectors to be electrically connected to the common output terminal or not, wherein the controller configures the control terminals of the selectors to allow a portion of the plurality of the sensing points to be electrically connected to the common output terminal, so as to proceed with a hierarchical block touch sensing.

2. The touch panel device as claimed in claim 1, wherein the controller configures the control terminals of the selectors, so as to group the sensing points into a plurality of blocks and to treat each block as a sensing unit, to perform the hierarchical block touch sensing.

3. The touch panel device as claimed in claim 2, wherein the sensing points have a total of M×N sensing points arranged on the panel in a matrix form including M sensing points in a first direction and N sensing points in a second direction, where M, N are each an integer greater than one.

4. The touch panel device as claimed in claim 3, wherein the controller groups the M×N sensing point into N1 first sensing blocks to perform N1 times of touch sensing, respectively, where N1 is an integer greater than one.

5. The touch panel device as claimed in claim 4, wherein the controller is based on a result of performing the N1 times of touch sensing to select one of the N1 first sensing blocks, and groups the sensing points of the selected first sensing block into N2 second sensing blocks to perform N2 times of touch sensing, respectively, where N2 is an integer greater than one.

6. The touch panel device as claimed in claim 5, wherein the controller is based on a result of performing the N2 times of touch sensing to select one of the N2 second sensing blocks, and groups the sensing points of the selected second sensing block into N3 third sensing blocks to perform N3 times of touch sensing, respectively, where N3 is an integer greater than one.

7. The touch panel device as claimed in claim 1, wherein each of the selectors comprises a lead, a resistor, a first diode, a second diode, and a switch.

8. The touch panel device as claimed in claim 7, wherein the lead is connected to the corresponding sensing point, the resistor has one end connected to the lead, the first diode has an anode connected to the other end of the resistor and a cathode connected to a high voltage, the second diode has a cathode connected to the other end of the resistor and an anode connected to a low voltage, and the switch has one end connected to the other end of the resistor, the other end connected to the common output terminal, and a control terminal connected to the controller.

9. The touch panel device as claimed in claim 3, wherein the first direction is substantially vertical to the second direction.

10. A touch sensing method implemented in a touch panel device with reconfigurable sensing points, the touch panel device having a plurality of sensing points arranged on a panel for sensing a touch generated from an external object, and a controller for grouping the plurality of sensing points into a plurality of blocks, and treating each block as a sensing unit, to proceed with a hierarchical block touch sensing, the method comprising:
using the controller to group the plurality of sensing points into N1 first sensing blocks, so as to perform N1 times of touch sensing, respectively, where N1 is an integer greater than one; and
using the controller to select one of the N1 first sensing blocks based on a result of performing the N1 times of touch sensing and to group the sensing points of the selected first sensing block into N2 second sensing blocks, so as to perform N2 times of touch sensing, respectively, where N2 is an integer greater than one.

11. The touch sensing method as claimed in claim 10, wherein the controller selects one of the N2 second sensing blocks based on a result of performing the N2 times of touch sensing, and groups the sensing points of the selected second sensing block into N3 third sensing blocks, so as to perform. N3 times of touch sensing, respectively, where N3 is an integer greater than one.

12. The touch sensing method as claimed in claim 11, wherein the sensing points have a total of M×N sensing points arranged on the panel in a matrix form including M sensing points in a first direction and N sensing points in a second direction, Where M, N are each an integer greater than one.

13. The touch sensing method as claimed in claim 12, wherein the first direction is substantially vertical to the second direction.

14. The touch sensing method as claimed in claim 13, wherein the touch panel device has a touch sensing resolution of N1×N2×N3 after performing N1+N2+N3 times of touch sensing.
